(19) United States
(12) Patent Application Publication
(10) Pub. No.: US 2019/0225214 A1
(43) Pub. Date: Jul. 25, 2019

(54) ADVANCED WILD-LIFE COLLISION AVOIDANCE FOR VEHICLES

(71) Applicant: Intel Corporation, Santa Clara, CA (US)

(72) Inventors: Daniel Pohl, Puchheim (DE); Stefan Menzel, Stockdorf (DE)

(21) Appl. No.: 16/370,906

(22) Filed: Mar. 30, 2019

(51) Int. Cl. B60W 30/09; B60W 30/095; G01S 5/00; A01K 11/00

(52) U.S. Cl. CPC B60W 30/09; A01K 11/008; G01S 5/0072; B60W 30/0956

(57) ABSTRACT

According to various aspects, a vehicle may include: one or more receivers, wherein the one or more receivers receive an animal tracking signal comprising animal attribute data from an animal tracking device configured to store animal attribute data; one or more processers, where in the processors are configured to process the animal attribute data to determine if an animal will be in the path of the vehicle and control the vehicle based on the determination that the animal will be in the path of the vehicle, and to further control the vehicle based on the animal attribute data and/or an animal behavior based on the animal attribute data.

### TECHNICAL FIELD

Various aspects relate generally to an animal tracking device transmitting an animal tracking signal to a vehicle equipped with at least one receiver and at least one processor to operate the vehicle to avoid collision with an animal based on animal attribute data received from the animal tracking signal.

### BACKGROUND

In general, modern vehicles may include various active and passive assistance systems to assist during driving the vehicle during an emergency. An emergency may be a predicted collision of the vehicle with an animal. The vehicle may include one or more receivers, one or more processors, and one or more sensors, e.g. image sensors, configured to predict a collision of the vehicle with an animal. Further, one or more autonomous vehicle systems may be implemented in a vehicle, e.g., to redirect the path of the vehicle, to more or less autonomously drive the vehicle, etc. As an example, an emergency brake assist (EBA), also referred to as brake assist (BA or BAS) may be implemented in the vehicle. The emergency brake assist may include a braking system that increases braking pressure in an emergency.

### BRIEF DESCRIPTION OF THE DRAWINGS

Throughout the drawings, it should be noted that like reference numbers are used to depict the same or similar elements, features, and structures. The drawings are not necessarily to scale, emphasis instead generally being placed upon illustrating aspects of the disclosure. In the following description, some aspects of the disclosure are described with reference to the following drawings, in which:

FIG. 1A shows an exemplary vehicle in communication with an animal tracking device;

FIG. 1B shows an exemplary animal tracking device in detail;

FIG. 2 shows an exemplary vehicle including a collision avoidance apparatus and in communication with multiple animal tracking devices;

FIG. 3 shows an exemplary vehicle including a collision avoidance apparatus and in communication with multiple animal tracking devices;

FIG. 4 shows an exemplary method of determining an animal's position through triangulation;

FIG. 5 shows an exemplary artificial intelligence tool used to predict an animal behavior and/or determine a collision avoidance action;

FIG. 6 shows an exemplary flow diagram of a method for avoiding collision of one or more animals with a vehicle, according to some aspects;

### DESCRIPTION

The following detailed description refers to the accompanying drawings that show, by way of illustration, specific details and aspects in which the disclosure may be practiced. These aspects are described in sufficient detail to enable those skilled in the art to practice the disclosure. Other aspects may be utilized and structural, logical, and electrical changes may be made without departing from the scope of the disclosure. The various aspects are not necessarily mutually exclusive, as some aspects can be combined with one or more other aspects to form new aspects. Various aspects are described in connection with methods and various aspects are described in connection with devices. However, it may be understood that aspects described in connection with methods may similarly apply to the devices, and vice versa.

The word “exemplary” is used herein to mean “serving as an example, instance, or illustration”. Any aspect or design described herein as “exemplary” is not necessarily to be construed as preferred or advantageous over other aspects or designs.

The terms “at least one” and “one or more” may be understood to include a numerical quantity greater than or equal to one (e.g., one, two, three, four, [. . . ], etc.). The term “a plurality” may be understood to include a numerical quantity greater than or equal to two (e.g., two, three, four, five, [. . . ], etc.).

The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of listed elements.

The words “plural” and “multiple” in the description and the claims expressly refer to a quantity greater than one. Accordingly, any phrases explicitly invoking the aforementioned words (e.g., “a plurality of [objects],” “multiple [objects]”) referring to a quantity of objects expressly refers to more than one of the said objects. The terms “group (of),” “set [of],” “collection (of),” “series (of),” “sequence (of),” “grouping (of),” etc., and the like in the description and in the claims, if any, refer to a quantity equal to or greater than one, i.e. one or more.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term data, however, is not limited to the aforementioned examples and may take various forms and represent any information as understood in the art.

The term “processor” as, for example, used herein may be understood as any kind of entity that allows handling data. The data may be handled according to one or more specific functions executed by the processor or controller. Further, a processor or controller as used herein may be understood as any kind of circuit, e.g., any kind of analog or digital circuit.

The term “handle” or “handling” as for example used herein referring to data handling, file handling or request handling may be understood as any kind of operation, e.g., an I/O operation, and/or any kind of logic operation. An I/O operation may include, for example, storing (also referred to as writing) and reading.

A processor may thus be or include an analog circuit, digital circuit, mixed-signal circuit, logic circuit, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

Differences between software and hardware implemented data handling may blur. A processor, controller, and/or circuit detailed herein may be implemented in software, hardware and/or as hybrid implementation including software and hardware.

The term “system” (e.g., a computing system, a memory system, a storage system, etc.) detailed herein may be understood as a set of interacting elements, wherein the elements can be, by way of example and not of limitation, one or more mechanical components, one or more electrical components, one or more instructions (e.g., encoded in storage media), and/or one or more processors, and the like.

The term “mechanism” (e.g., a spring mechanism, etc.) detailed herein may be understood as a set of interacting elements, wherein the elements can be, by way of example and not of limitation, one or more mechanical components, one or more electrical components, one or more instructions, etc.

As used herein, the term “memory”, “memory device”, and the like may be understood as a non-transitory computer-readable medium in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, etc., or any combination thereof. Furthermore, it is appreciated that registers, shift registers, processor registers, data buffers, etc., are also embraced herein by the term memory. It is appreciated that a single component referred to as “memory” or “a memory” may be composed of more than one different type of memory, and thus may refer to a collective component including one or more types of memory. It is readily understood that any single memory component may be separated into multiple collectively equivalent memory components, and vice versa. Furthermore, while memory may be depicted as separate from one or more other components (such as in the drawings), it is understood that memory may be integrated within another component, such as on a common integrated chip.

According to various aspects, information (e.g., vector data) may be handled (e.g., processed, analyzed, stored, etc.) in any suitable form, e.g., data may represent the information and may be handled via a computing system.

The term “map” used with regards to a two- or three-dimensional map may include any suitable way of describing positions of objects in the two- or three-dimensional space. According to various aspects, a voxel map may be used to describe objects in the three dimensional space based on voxels associated with objects. To prevent collision based on a voxel map, ray-tracing, ray-casting, rasterization, etc., may be applied to the voxel data.

According to various aspects, the term “predict” used herein with respect to “predict a collision”, “predict a threat”, “predicted animal behavior”, etc., may be understood as any suitable type of determination of a possible collision between an animal and a vehicle.

In some aspects, one or more range imaging sensors may be used for sensing objects in a vicinity of a vehicle. A range imaging sensor may allow associating range information (or in other words distance information or depth information) with an image, e.g., to provide a range image having range data associated with pixel data of the image. This allows, for example, providing a range image of the vicinity of the vehicle including range information about one or more objects depicted in the image. The range information may include, for example, one or more colors, one or more shadings associated with a relative distance from the range image sensor, etc. According to various aspects, position data associated with positions of objects relative to the vehicle and/or relative to an assembly of the vehicle may be determined from the range information. According to various aspects, a range image may be obtained, for example, by a stereo camera, e.g., calculated from two or more images having a different perspective. Three-dimensional coordinates of points on an object may be obtained, for example, by stereophotogrammetry, based on two or more photographic images taken from different positions. However, a range image may be generated based on images obtained via other types of cameras, e.g., based on time-of-flight (ToF) measurements, etc. Further, in some aspects, a range image may be merged with additional sensor data, e.g., with sensor data of one or more radar sensors, etc.

As an example, a range image may include information to indicate a relative distance of objects displayed in the image. This distance information may be, but is not limited to, colors and/or shading to depict a relative distance from a sensor. Based on (e.g. a sequence of) range images, a three dimensional map may be constructed from the depth information. Said map construction may be achieved using a map engine, which may include one or more processors or a non-transitory computer readable medium configured to create a voxel map (or any other suitable map) from the range information provided by the range images. According to various aspects, a moving direction and a velocity of a moving object, e.g. of a moving obstacle approaching a vehicle, may be determined via a sequence of range images considering the time at which the range images where generated.

One or more aspects are related to a vehicle. The term “vehicle” as used herein may be understood as any suitable type of vehicle, e.g., a motor vehicle also referred to as automotive vehicle. As an example, a vehicle may be a car also referred to as a motor car, a passenger car, etc. As another example, a vehicle may be a truck (also referred to as motor truck), a van, etc. However, despite various aspects may be described herein for motor vehicles (e.g., a car, a truck, etc.), a vehicle may also include any type of ships, drones, airplanes, tracked vehicles, boat, etc.

The term “wildlife” as used herein may be understood to include any animal, wild or domestic, that may come into the path of a vehicle.

In general, wildlife vehicle collisions are a big problem. There are 725,000 to 1.5 million collisions every year in the United States of America alone, causing 200 human fatalities and almost 30,000 injuries annually. The use of technology to prevent or reduce vehicle collisions with animals can save lives.

The movement of wildlife is difficult to predict. To avoid vehicle collisions with animals, human drivers have had to react manually with regard to the potential threat of a collision with wildlife.

More recently, vehicles have been equipped with image sensors to capture the image of an animal and match an image against a database of masses and shapes to determine the type of animal and estimate its behavior. This is limited to images captured during daylight hours or within the range of the vehicle's headlights.

These automated systems can detect wildlife and will apply the vehicle's brakes if possible. However, no other action than braking is taken.

According to various aspects, a system is provided that may track animal movement and predict an animal's path and/or behavior to identify a vehicle action that may prevent a vehicle collision with the animal.

In various aspects, tracking wildlife may be used to more accurately predict wildlife movement which can save both human and animal lives. Additionally, using methods other than braking alone may help prevent a collision. For example, honking the horn of a vehicle might scare the animal out of the path of the vehicle, increasing the chance of avoiding a collision.

Additionally, vehicles can reduce bright headlights as to not blind animals and have them freeze in their position if they are in the path of a moving vehicle.

If a route, is deemed to be high risk for the current path of the vehicle an alternate route may be offered. For example, if several deer are tracked near a local highway a route via an interstate may be desirable if it historically has a lower rate of animal collisions.

Various aspects may include the use of wide scale animal tracking, artificial intelligence tools such as an artificial neural network to predict animal movement or behavior, and 4G/5G networks to enhance vehicle reaction to a potential wildlife collision.

Wildlife animal tracking devices that send an animal's position are already in existence. Such devices may be affixed to the animal by implanting the device in the animal, attaching the device to the surface of the animal, or by other possible means. Further, the animal tracking devices may be equipped with memory to store animal attribute data. Animal attribute data might include the velocity of the animal using microgyros, or the acceleration of the animal using accelerometers. Various aspects include the use of wide scale animal tracking. For example, in Germany, wildlife is monitored by hunters which actively monitor the size of the wildlife population.

With the use of animal tracking devices to track all wildlife, a vehicle can receive animal attribute data to help avoid collisions. The animal tracking device may send an animal tracking device to vehicles. Upon receiving the animal tracking signal comprising animal attribute data, the vehicle can combine data with their navigational mapping systems and also animal warning systems to help avoid a collision with the animal.

Many types of vehicles could benefit from this technology. For example, endangered manatees are often struck by propellers and injured or killed. If boats were equipped with technology to identify track manatees equipped with an animal tracking device, water crafts could maintain a certain distance of a tracked manatee, steer away from an area with manatees, or reduce speed to a safe speed for manatees.

As another example, many migratory birds are already tracked. A plane may be alerted to a flock of migratory birds approaching its take off path and delay takeoff or choose a different takeoff direction.

Furthermore, the animal tracking devices may communicate via an ad-hoc network as opposed to a fixed network. The animal tracking devices would communicate with other animal tracking devices and the vehicles to triangulate the position of an animal. Using multiple tracked animals and one or more vehicles, even without GPS, the vehicle would be able to determine the position of wildlife by triangulating the signal strength and direction of the animal tracking signal.

In another aspect of this disclosure, the animal tracking device would send an animal tracking signal directly to the cloud or an intermediary communication device. Vehicles would then receive the animal tracking signal and its associated animal attribute data from the cloud or intermediary communication device before combining the data with their navigational mapping systems and animal warning system and/or indicator.

In addition to using the direction, velocity, and acceleration associated with the animal tracking signal, other animal attributes can be used to predict animal behavior. For example, an artificial intelligence tools can be used to predict animal movement and/or behavior based on the animal attribute data from the animal tracking signal.

In one aspect of this disclosure, a trained neural network for wildlife movement prediction using the data from the animal tracking signal may predict an animal movement and be further trained. The neural network may be hosted in the cloud and the results of animal movement prediction and/or behavior may be transmitted to the vehicle.

For example, a global neural network for prediction of general wild-life movements can use data for all tracked animals.

As another example, a neural network of wild-life movements within a local distance may be used to more accurately predict animal movement and/or behavior. For example, only data for animals tracked within a 5 km radius of the vehicle's position may be used to train a neural network. This may be provided because the same species of animal may have different behaviors within different, localized, populations. For example, deer in an urban area may behave differently than deer in a rural area. Predictions based on a local population may be more accurate than the predictions based on national or global populations.

Additionally, the time of year and sex may help determine animal movement and/or behavior. For example, autumn is often the rutting season for deer when bucks are relentlessly pursuing does. A buck's behavior during this time of year may differ from its behavior at other times of year.

In another example, data other than animal attribute data may be provided and used. Using real-time data from within the last few hour, a vehicle can receive data that a specific street through a forest has not had any vehicle traffic. Such data might indicate that wildlife are more likely to approach a road because it has not had any recent vehicle traffic. Wildlife tracking data indicate that wildlife is slowly heading towards the street. Using the live wildlife tracking data and the historical vehicle traffic data, an artificial intelligence tool may predict that the vehicle is approaching a possible collision with the wildlife.

In yet another example, recent heavy rain close to an area where a vehicle is driving has caused flooding nearby. From historical data we can determine that at times like this, animals tend to move away from flooded areas and directly toward the road where the vehicle is driving. Because of the increased risk of encountering wildlife, the collision avoidance apparatus may reduce the speed of our vehicle or suggest an alternate route that has a lower risk of collision with wildlife.

Other data that may be useful in determining animal behavior include:
Species
Sex
Position
Direction
Velocity
Acceleration
Time of year
Time of day
Age
Single animal vs multiple animals
Surroundings
Weather

It is understood that the above list is not exhaustive and that other input data may be used to determine animal behavior.

One effect the collision avoidance apparatus may have is that an animal does not have to be visible in order to determine that it may come into the path of the moving vehicle.

An alternative to hosting artificial intelligence tools on the cloud could be having it stored on a vehicle memory. Having the pre-trained neural network stored on the vehicle, the vehicle would receive live data and process it using the stored the neural network. The animal tracking signals within a certain vicinity of the vehicle, would transmit the data to the vehicle. The data from these signals would serve as input for the pre-trained neural network and be processed live on the vehicle.

Many factors can be used by an artificial intelligence tool to determine an animal movement. Historic data of how wildlife reacts to vehicles can be used to train an artificial intelligence tool. Many different input data, such as live and/or historical data, can be used to make an animal movement/behavior prediction. For example, is the animal alone or accompanied by other animals such as an animal in a herd. Whether or not there is a predatory animal in the vicinity of a prey animal. For example a predator chasing a prey animal. Data regarding if there is an animal of the opposite sex or young and old animals within the vicinity. Such as a mother with her young. All such examples can be factors may be used as input to an artificial intelligence tool, such as a neural network, to determine how an animal may move or behave.

In addition to using animal attribute data from an animal tracking device to determine an animal movement, imaged based detection can be used to compliment the collision avoidance system to help avoid animal collisions. Again artificial intelligence tools can be trained to take images as input and determine if there is an animal. This can be done without having the animal completely visible. For example, if only deer antlers are visible in the image, the artificial intelligence tool can be trained to determine that the animal is a buck based solely on the antlers being visible in the image. Compared to existing systems, this would also allow animal detection if the animal is not fully visible within an image, e.g. only the antlers and head of a wild-life animal are captured by the vehicle's image sensors.

A vehicle's image sensors may also be used to generate a map of the vehicle's surroundings to help identify a safe vehicle action. For example, if there is a ditch in the side of the road maneuvering the vehicle into the ditch to avoid an animal might be undesirable.

Automatic systems designed to brake to slow or stop the vehicle upon detecting that there may be a vehicle collision with an animal may not be the best option. Vehicle actions other than braking may be provided. For example, effort to motivate an animal to move out of the path of the vehicle could be implemented to avoid collision. This could be critical, specifically if full braking will only lessen the impact, but not fully avoid it.

In the German official guide on how to react upon wild-life encounters, it states: “wildlife is blinded by high beam lights. An animal will keep standing as if petrified inside the light cone. Therefore, high beams should be turned off right away, when a wildlife animal is detected on a potential collision course. Further, it is advised to honk the horn to motivate the animal move away in addition to already established protocol of slowing down or stopping.”

Wide-scale use of wild animal tracking devices is already happening on a large scale in countries like Germany. By taking advantage of tracked animals, animal attribute data may be used to help predict animal behavior and prevent vehicle collisions with animals. As animal tracking devices become smaller and cheaper, animal telemetry can be expected to cover more and more wildlife. Animal tracking data for large populations of wildlife can increase the accuracy of artificial intelligence tools to for making wildlife movement predictions.

While animal behavior cannot be predicted with 100% certainty, artificial intelligence tools trained to predict a most likely scenario given input data can give the best vehicle response to create the greatest chance to avoid a collision.

Having animal tracking devices tracking the position, velocity, and acceleration of an animal can be used directly to predict the current path of the animal without the use of an artificial intelligence tool. This way the vehicle can anticipate wildlife within its vicinity coming into its path even if the wildlife are hidden behind trees or a small hill.

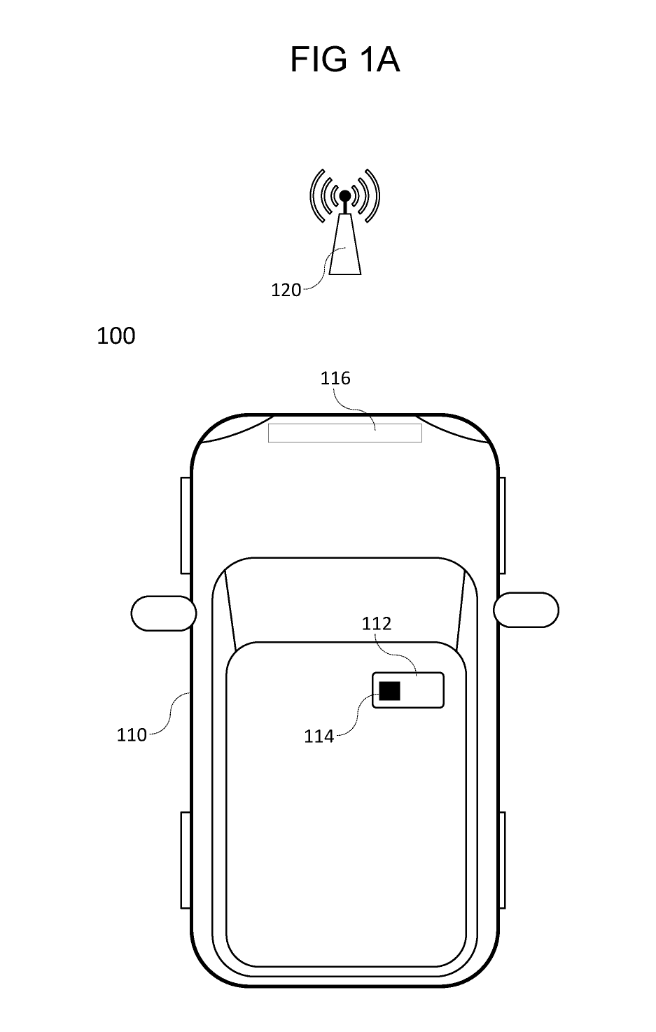

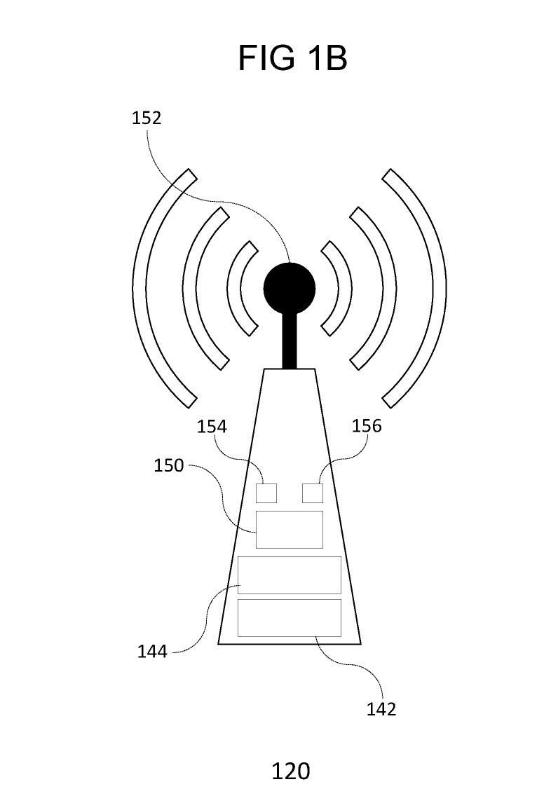

FIG. 1A illustrates a vehicle collision avoidance apparatus, according to various aspects. The vehicle 110 may include at least one processor 112, at least one receiver 114, and one or more image sensors 116. The animal tracking device 120 may transmit an animal tracking signal containing animal attribute data to the at least one receiver 114.

FIG. 1B illustrates animal tracking device 120 in more detail. The animal tracking device 120 may be affixed to an animal. For example it may be implanted into the animal or part of a collar attached to the animal. Animal tracking device 120 may include battery 142, memory 144, one or more processors 150, transmitter 152, GPS sensor 154, and accelerometer 156. Battery 142 serves as the power supply for animal tracking device 120. GPS sensor 154 and accelerometer 156 may measure position and acceleration data of the animal respectively. Animal attribute data, such as position data and acceleration data, may be stored in memory 144. Processor 150 may process the animal attribute data stored in memory 144 or directly from sensors 154 and 156. Processor 150 may generate an animal tracking signal including animal attribute data to be transmitted by transmitter 152. It should be understood that animal tracking device 120 may include any number of sensors to measure other animal attributes. For example, animal tracking device 120 may include a thermometer to measure the animal's temperature. Animal tracking device 120 may also include a receiver (not shown) to receive signals. It should be further understood that although some aspects are shown as separate components, they could be combined in to one component. For example, processor 150 and memory 144 may be one component.

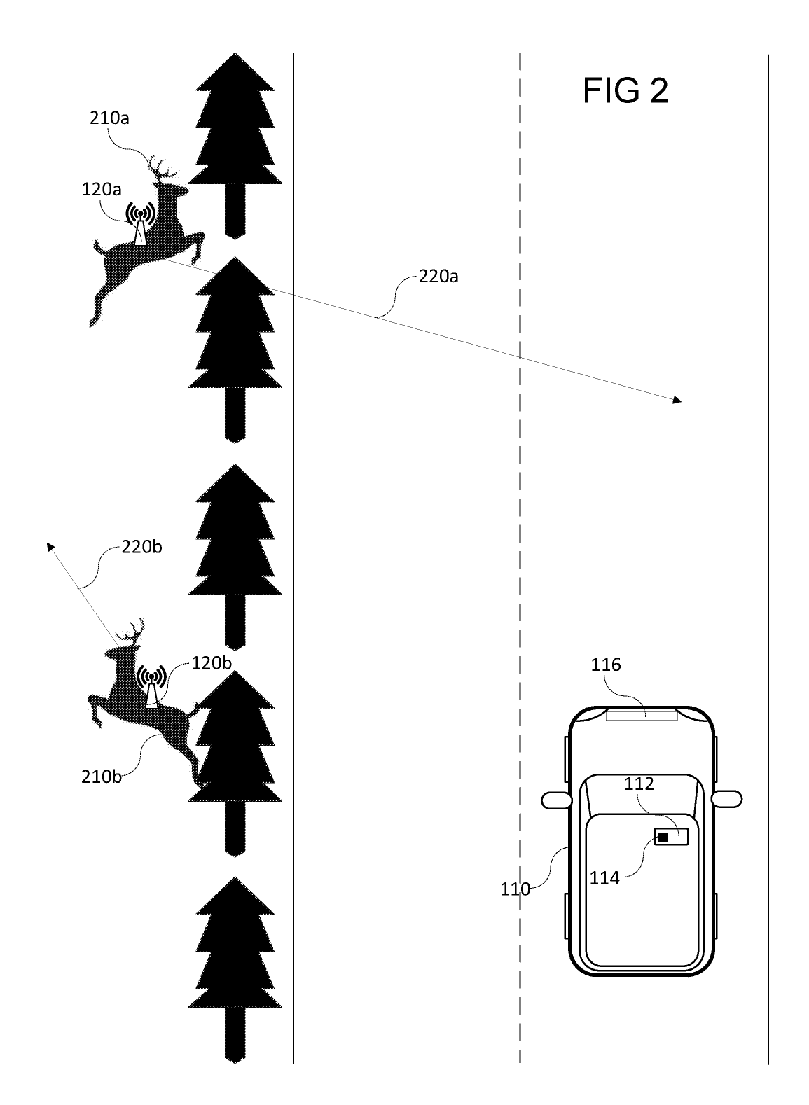

FIG. 2 illustrates a vehicle equipped with a vehicle collision avoidance apparatus as described in FIG. 1 receiving multiple animal tracking signals (not shown) from multiple animals 210a and 210b. Animal tracking devices 120a and 120b are affixed to animals 210a and 210b respectively. Animal tracking devices 120a and 120b are equipped with memory to store animal attribute data relating to animals 210a and 210b respectively. Among the animal attribute data stored on animal tracking devices 120a and 120b may be position data, direction data, velocity data, and/or acceleration data. One or more receivers 114 of vehicle 110 are able to receive animal tracking signals transmitted by animal tracking devices 120a and 120b. In some aspects of this disclosure, the animal tracking signal may pass through an intermediary communication device (not shown) from animal tracking devices 120a and 120b to receiver 114.

Upon one or more receivers 114 of vehicle 110 receiving multiple animal tracking signals from animal tracking devices 120a and 120b, one or more processors 112 process the animal attribute data transmitted as part of the animal tracking signal. For example, based on at least the position data, direction data, velocity data, and/or acceleration data of animal 210a, one or more processors 112 may determine that animal 210a has a projected path of 220a and will be in the path of the vehicle 110. Based on the determination that animal 210a will be in the path of vehicle 110, processors 112 may control vehicle 110 to reduce its headlights as to not blind the animal 210a, honk its horn to scare animal 210a out of the path of vehicle 110, change lanes to avoid a collision with animal 210a and any number of vehicle actions that may prevent a collision between vehicle 110 and animal 210a.

In another example, based on at least the position data, direction data, velocity data, and/or acceleration data of animal 210b, one or more processors 112 may determine that animal 210b has a projected path of 220b and will not be in the path of the vehicle 110. Based on the determination that animal 210b will be not in the path of vehicle 110, processors 112 may determine that no vehicle action is necessary to avoid a collision with animal 210b.

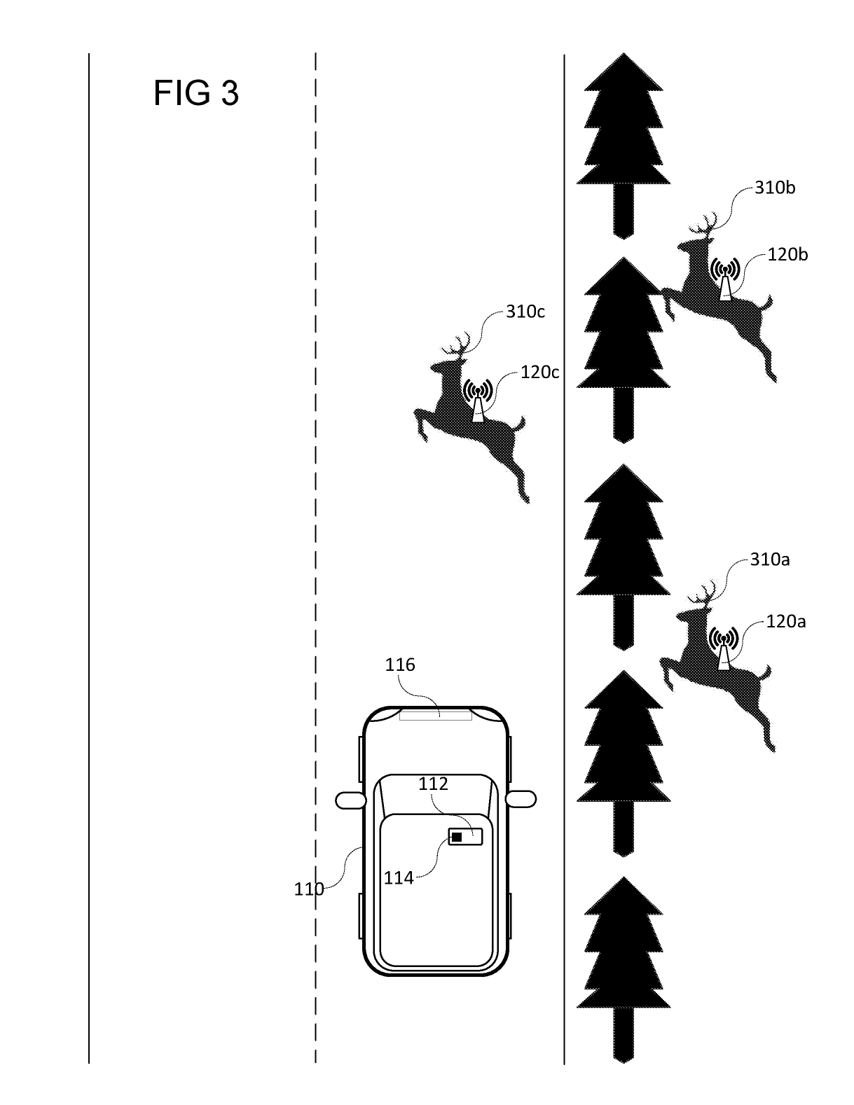

FIG. 3 illustrates a vehicle equipped with a vehicle collision avoidance apparatus as described in FIG. 1 and multiple animals 310a-310c with their respective animal tracking devices 120a-120c. One or more receivers 114 of vehicle 110 are able to receive animal tracking signals transmitted by animal tracking devices 120a and 120b as described in FIG. 2. By receiving animal tracking signals from animals 310a-310c, one or more processors 112 of vehicle 110 may determine that there are animals within the vicinity of vehicle 110 even when the view of the animals is obstructed.

For example, the view from the perspective of vehicle 110 of animals 310a and 310b may be obstructed by trees or any other obstacle. Even though animals 310a and 310b may not be visible, processors 112 may control the vehicle based on the animal attribute data of animal tracking signal received by one or more receivers 114 and transmitted by animal tracking devices 120a and 120b.

In addition to determining the presence of animals by receiving an animal tracking signal, vehicle 110 may also be equipped with one or more image sensors 116 to determine the presence of an animal. For example, one or more receivers 114 may receive animal attribute data for animal 310c from animal tracking signal transmitted by animal tracking device 120c. Additionally, one or more image sensors 116 may capture images of animal 310c because there is an unobstructed view of animal 310c from the perspective of vehicle 110. One or more processors 112 may process the animal attribute data and the captured images in tandem to determine a vehicle action. By using both animal attribute data and captured images, processors 112 may be able to determine the best vehicle action.

Additionally, one or more image sensors 116 may be able to capture images of the vehicle's vicinity to generate a map. One or more processors 112 may also use the map to determine a safe vehicle action based on the map of the vehicle's 110 surroundings.

Additionally, one or more image sensors 116 may be able to capture images of partially obstructed animals. For example, image sensors 116 may have a partial view of animals 310a and 310b. Processors may be able to determine the presence of animals 310a and 310b from the images captured of partially obstructed animals by image sensors 116. Again, one or more processors 112 may process the animal attribute data and the captured images in tandem to determine a vehicle action. By using both animal attribute data and captured images, processors 112 may be able to determine the best vehicle action.

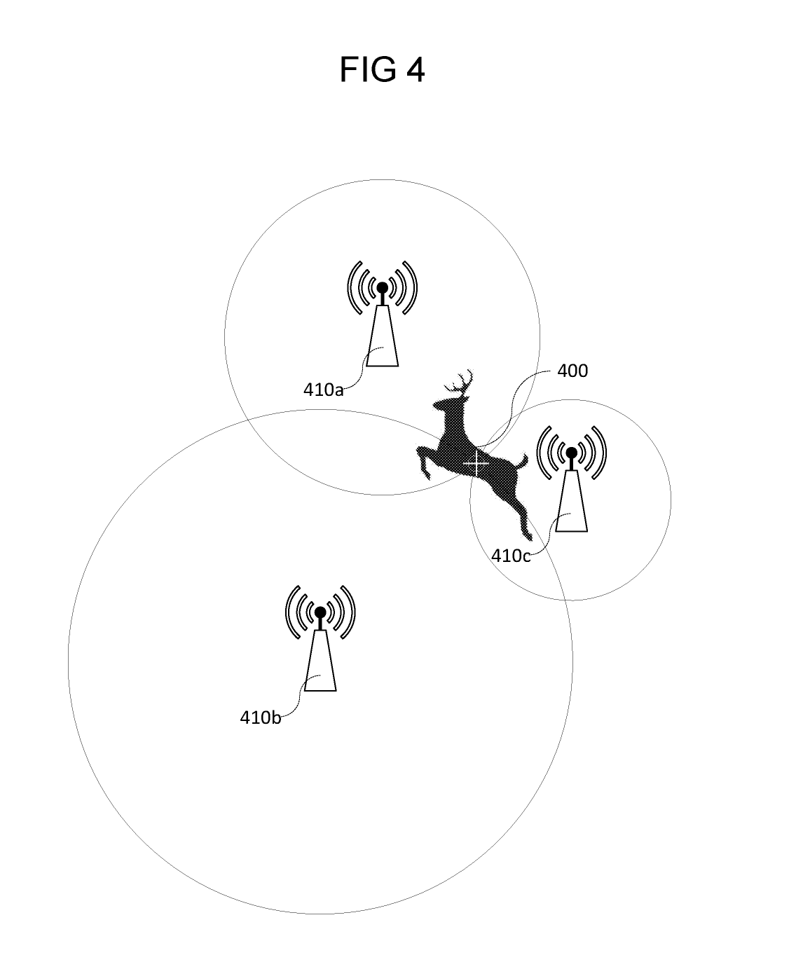

FIG. 4 illustrates an ad-hoc network used to determine the position of animal 400 even without GPS. Communication Devices 410a-410c may be any device able to receive the animal tracking signal transmitted by the animal tracking device affixed to animal 400 and transmitting at least the animal tracking signal's strength and direction. By measuring the signal strength and direction from three different points, the positions of communication devices 410a-410c, the position of animal 400 may be determined. Communication Devices 410a-410c may be other animal tracking devices, vehicles, and/or any other communication device.

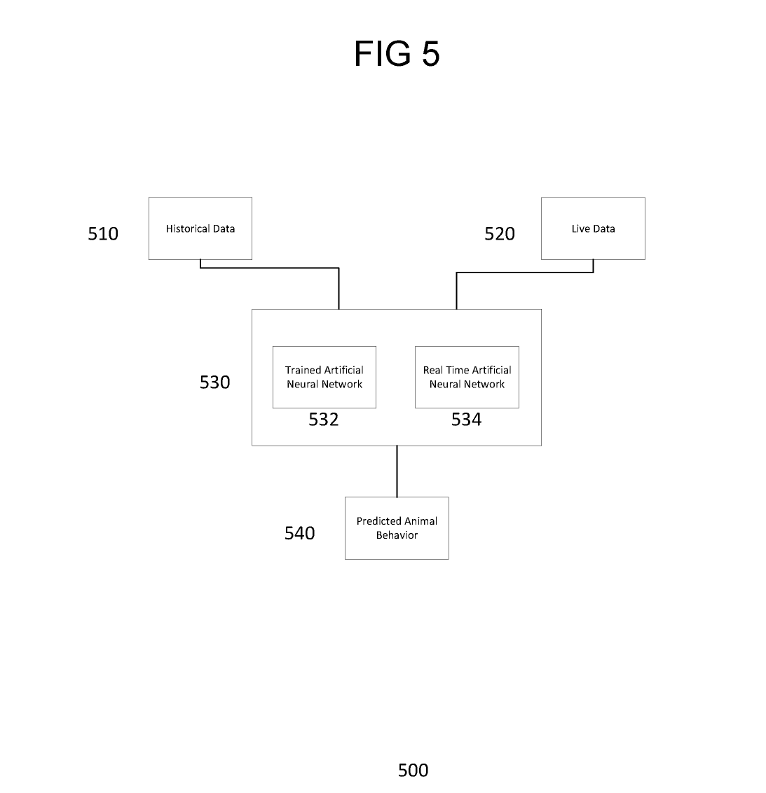

FIG. 5 illustrates a schematic view 500 of an artificial intelligence tool 530 that may be trained to determine a most likely animal behavior or movement. Artificial intelligence tool 530 may take as input historical data 510 and/or live data 520. Historical data 510 and/or live data 520 may be used to train artificial intelligence tool 530. Historical data 510 and live data 520 may be any data useful in predicting the behavior or movement of an animal. For example, historical data 510 may include animal behavior during periods of floods. Based on the historical data, it might be observed that animals move away from the source of the flood and potentially towards roads and in the paths of vehicles. Live data 520 may include the animal attributes included with a received animal tracking signal to help determine the actions of the current animal that is within the vicinity of the vehicle. For example, live data 520 may include the direction of an animal to determine if it will come into the path of the vehicle. Live data 520 may also include data not attributed to the animal such as current weather conditions. For example, if it is raining, braking to avoid a collision may not be the best option because the road conditions may be slick.

Artificial intelligence tool 530 may be any model able to accept historical and/or live data to predict animal behavior. For example, artificial intelligence tool 530 may include trained artificial neural network 532 and/or real time artificial neural network 534. For example, using live data 520 and/or historical data 510 as input into artificial intelligence tool 530, trained artificial neural network 532 and/or real time artificial neural network 534 may determine if an animal will behave in a manner that puts it in the path of a vehicle and as output generate an animal behavior prediction 540. For example, 540 may be a predicted animal movement. Additionally, 540 might determine other animal behavior. For example if honking the horn of the vehicle may help in startling the animal and provoke them to move out of the path of the vehicle.

One or more processors 112 of vehicle 110 may determine a defensive action to avoid a collision between the vehicle and the animal based on the predicted animal behavior.

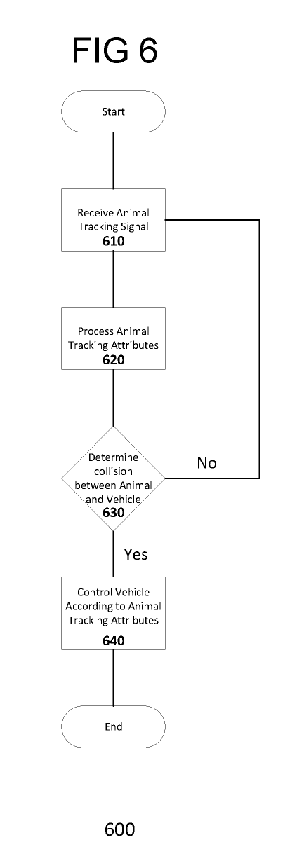

FIG. 6 illustrates a schematic flow diagram of exemplary method 600 for controlling a vehicle to avoid a collision with wildlife. The method may include: in 610 receiving an animal tracking signal form an animal tracking device which includes animal tracking attribute data; in 620 processing animal tracking attribute data; in 630 determining if the animal will come into the path of the vehicle; and in 640 controlling the vehicle based on determining whether or not the animal will come into the path of the vehicle.

According to some aspects, receiving the animal tracking signal 610 may be received directly from the animal tracking device or an intermediary communication device.

According to some aspects, processing the animal tracking attributes 620 associated with the animal may be processed by the processers on the vehicle and may include the use of artificial intelligence tool stored on a memory of the vehicle.

According to some aspects, processing the animal tracking attributes 620 associated with the animal may be processed by transmitting an input signal, comprised of animal attribute data (live data), to an artificial intelligence tool hosted in the cloud which outputs a predicted animal behavior. Processing the animal tracking attribute data 620 may further include receiving the predicted animal behavior output from the cloud.

According to some aspects, controlling the vehicle 640 may be based on the predicted animal behavior output of an artificial intelligence tool. For example, honking the horn if the predicted animal behavior indicates that honking the horn will startle the animal into moving out of the path of the vehicle.

It should be understood that any steps of method 600 may be performed by the processors of the vehicle or in the cloud. Additionally, the vehicle may be equipped to transmit or receive data as necessary to communicate with the cloud, animal tracking devices, other vehicles, etc., in order to perform the steps of method 600.

In the following, various examples are provided with reference to the aspects described above.

Example 1 is a vehicle controlling apparatus. The vehicle controlling apparatus includes one or more receivers configured to receive an animal tracking signal from an animal tracking device affixed to an animal and storing animal attribute data associated with the animal. The animal tracking signal includes the animal attribute data. The vehicle controlling apparatus further includes one or more processors configured to process the received the animal attribute data to determine the animal will be in a path of the vehicle; determine a vehicle action based on the determination that the animal will be in the path of the vehicle, and control a vehicle according to the vehicle action.

In Example 2, the subject matter of Example 1 can optionally include that the one or more receivers receive the animal tracking signal via an intermediary transceiver.

In Example 3, the subject matter of any of Examples 1 or 2 can optionally include that the vehicle controlling apparatus further includes one or more transmitters. The one or more transmitters are configured to transmit an input signal including the animal attribute data to a server.

In Example 4, the subject matter of Example 3 can optionally include that the server is further configured to predict an animal movement based on the animal attribute data and transmit the animal movement to the vehicle. The vehicle is configured to receive the animal movement from the server and determine the vehicle action based on the animal movement.

In Example 5, the subject matter of any of Examples 1-3 can optionally include that the one or more processors determine an animal movement based on the animal attribute data.

In Example 6, the subject matter of any of Examples 1-5 can optionally include that the animal attribute data includes a species attribute.

In Example 7, the subject matter of any of Examples 1-6 can optionally include that the animal attribute data includes a sex attribute.

In Example 8, the subject matter of any of Examples 1-7 can optionally include that the animal attribute data includes a velocity attribute.

In Example 9, the subject matter of any of Examples 1-8 can optionally include that the animal attribute data includes an acceleration attribute.

In Example 10, the subject matter of any of Examples 1-9 can optionally include that the vehicle action is to modify a light brightness.

In Example 11, the subject matter of any of Examples 1-10 can optionally include that the vehicle action is to produce a sound.

In Example 12, the subject matter of any of Examples 1-11 can optionally include that the vehicle action is to alter a vehicle direction.

In Example 13, the subject matter of any of Examples 1-12 can optionally include an indicator. The one or more processors are configured to enable the indicator.

In Example 14, the subject matter of Example 13 can optionally include that the indicator is configured to indicate a high risk route.

In Example 15, the subject matter of Example 14 can optionally include that the one or more processors are configured to provide an alternate route.

In Example 16, the subject matter of any of Examples 1-15 can optionally include one or more image sensors configured to capture an image.

In Example 17, the subject matter of Example 16 can optionally include that the one or more processors are configured to process the captured image to determine an animal.

In Example 18, the subject matter of Example 17 can optionally include that the captured image is an obstructed view of the animal.

In Example 19, the subject matter of any of Examples 17 and 18 can optionally include that the vehicle action is further based on the determined animal.

In Example 20, the subject matter of any of Examples 1-19 can optionally include that the vehicle is an aircraft.

In Example 21, the subject matter of any of Examples 1-19 can optionally include the vehicle is a watercraft.

In Example 22, the subject matter of any of Examples 1-19 can optionally include that the vehicle is an automobile.

In Example 23, the subject matter of any of Examples 1-22 can optionally include that the vehicle action is further based on weather conditions.

Example 24 is a system for vehicle control having one or more animal tracking devices affixed to an animal configured to transmit an animal tracking signal and store animal attribute data associated with the animal. The animal tracking signal includes the animal attribute data. The vehicle control system further having one or more receivers configured to receive the animal tracking signal; and one or more processors configured to process the received animal attribute data to determine the animal will be in a path of the vehicle. The system for vehicle control can determine a vehicle action based on the determination that the animal will be in the path of the vehicle and control the vehicle according to the vehicle action.

In Example 25, the subject matter of Example 24 including an intermediary transceiver. The animal tracking signal is transmitted from the animal tracking device to the vehicle via the intermediary transceiver.

In Example 26, the subject matter of Example 25 can optionally include that the vehicle further having one or more transmitters configured to transmit an input signal including the animal attribute data to the server.

In Example 27, the subject matter of Example 26, can optionally include that the server is configured predict an animal movement based on the animal attribute data. The server can optionally transmit the animal movement to the vehicle. The vehicle can receive the animal movement and determine the vehicle action based on the animal movement.

In Example 28, the subject matter of any of Examples 24-26, can optionally include that the one or more processors are further configured to determine an animal movement based on the animal attribute data.

In Example 29, the subject matter of any of Examples 24-28, can optionally include that the animal attribute data includes a species attribute.

In Example 30, the subject matter of any of Examples 24-29, can optionally include that the animal attribute data includes a sex attribute.

In Example 31, the subject matter of any of Examples 24-30, can optionally include that the animal attribute data includes a velocity attribute.

In Example 32, the subject matter of any of Examples 24-31, can optionally include that the animal attribute data includes an acceleration attribute

In Example 33, the subject matter of any of Examples 24-32, can optionally include that the vehicle action is to modify a light brightness.

In Example 34, the subject matter of any of Examples 24-33, can optionally include that the vehicle action is to produce a sound.

In Example 35, the subject matter of any of Examples 24-34, can optionally include that the vehicle action is to modify a vehicle path.

In Example 36, the subject matter of any of Examples 24-34, can optionally include an indicator. The one or more processors are further configured to enable the indicator.

In Example 37, the subject matter of Example 36, can optionally include that the indicator is configured to indicate a high-risk route.

In Example 38, the subject matter of Example 37, can optionally include that the one or more processors are further configured to provide an alternate route.

In Example 39, the subject matter of any of Examples 24-38 can optionally include one or more image sensors configured to capture an image.

In Example 40, the subject matter of Example 39, can optionally include that the one or more processors are further configured to process the captured image to determine an animal.

In Example 41, the subject matter of Example 40, can optionally include that the captured image is an obstructed view of the animal.

In Example 42, the subject matter of any of Examples 40-41, can optionally include that the vehicle action is based on the determined animal.

In Example 43, the subject matter of any of Examples 24-42, can optionally include that the vehicle is an aircraft.

In Example 44, the subject matter of any of Examples 24-42, can optionally include that the vehicle is a watercraft.

In Example 45, the subject matter of any of Examples 24-42, can optionally include that the vehicle is an automobile.

In Example 46, the subject matter of any of Examples 24-45, can optionally include that the vehicle action is further based on weather conditions.

Example 47 is an apparatus for controlling a vehicle having means to receive an animal tracking signal from an animal tracking device affixed to an animal and storing animal attribute data associated with the animal. The apparatus also includes means to process the received animal attribute data to determine that the animal will be in a path of a vehicle and determine a vehicle action based on the determination that the animal will be in the path of the vehicle. The apparatus further having means to control the vehicle according to the vehicle action.

In Example 48, the subject matter of Example 47, optionally including means to receive the animal tracking signal via an intermediary transceiver.

In Example 49, the subject matter of any of Examples 47 and 48, optionally including means to transmit an input signal including the animal attribute data to a server.

In Example 50, the subject matter of Example 49, optionally including means of receiving an animal movement based on the animal attribute data from the server.

In Example 51, the subject matter of any of Examples 47-49, optionally including means to determine an animal movement based on the animal attributes.

In Example 52, the subject matter of any of Examples 47-51, optionally including that the animal attributes includes a species attribute.

In Example 53, the subject matter of any of Examples 47-52, optionally including that the animal attributes includes a sex attribute.

In Example 54, the subject matter of any of Examples 47-53, optionally including that the animal attributes includes a velocity attribute.

In Example 55, the subject matter of any of Examples 47-54, optionally including that the animal attributes includes an acceleration attribute

In Example 56, the subject matter of any of Examples 47-55, optionally including means to modify a light brightness.

In Example 57, the subject matter of any of Examples 47-56, optionally including means to produce a sound.

In Example 58, the subject matter of any of Examples 47-57, optionally including means to swerve.

In Example 59, the subject matter of any of Examples 47-58, optionally including means to enable an indicator.

In Example 60, the subject matter of Example 59, optionally including means to indicate a high risk route.

In Example 61, the subject matter of Example 60, optionally including means to provide an alternate route.

In Example 62, the subject matter of any of Examples 47-61 optionally including means to capture an image.

In Example 63, the subject matter of Example 62, optionally including means to process the captured image to determine an animal.

In Example 64, the subject matter of Example 63, optionally including that the captured image is an obstructed view of the animal.

In Example 65, the subject matter of any of Examples 63 and 64, optionally including that the vehicle action is based on the determined animal.

Example 66 is a method for animal collision avoidance including receiving an animal tracking signal from an animal tracking device storing animal attribute data and affixed to an animal. The animal tracking signal includes the animal attribute data. The method further including processing the received animal attribute data to determine the animal will be in a path of the vehicle action and determining a vehicle action based on the determination that the animal will be in the path of the vehicle. The process also including controlling a vehicle according to the vehicle action.

In Example 67, the subject matter of Example 66, can optionally include receiving the animal tracking signal via an intermediary transceiver.

In Example 68, the subject matter of any of Examples 66 and 67, can optionally include transmitting an input signal including the animal attribute data to a server.

In Example 69, the subject matter of Example 68 can optionally include receiving an animal movement based on the animal attribute data and that the vehicle action is further determined based on the animal movement.

In Example 70, the subject matter of any of Examples 66-68, can optionally include determining an animal movement based on the animal attribute data.

In Example 71, the subject matter of Example 70, can optionally include that the vehicle action is based on the determined animal movement.

In Example 72, the subject matter of any of Examples 66-71, can optionally include that the animal attributes includes a species attribute.

In Example 73, the subject matter of any of Examples 66-72, can optionally include that the animal attributes includes a sex attribute.

In Example 74, the subject matter of any of Examples 66-73, can optionally include that the animal attributes includes a velocity attribute.

In Example 75, the subject matter of any of Examples 66-74, can optionally include that the animal attributes includes an acceleration attribute

In Example 76, the subject matter of any of Examples 66-75, can optionally include that the vehicle action includes modifying a light brightness.

In Example 77, the subject matter of any of Examples 66-76, can optionally include that the vehicle action includes producing a sound.

In Example 78, the subject matter of any of Examples 66-77 can optionally include that the vehicle action includes swerving.

In Example 79, the method of any of Examples 66-78 can optionally include enabling an indicator.

In Example 80, the subject matter of Example 79 can optionally include indicating a high risk route.

In Example 81, the subject matter of Example 80 can optionally include providing an alternate route.

In Example 82, the subject matter of any of Examples 66-can optionally include capturing an image.

In Example 83, the subject matter of Example 82 can optionally include determining an animal based on the captured image.

In Example 84, the subject matter of Example 83 can optionally include that the captured image is an obstructed view of the animal.

In Example 85, the subject matter of any of Examples 83 and 84 can optionally include that the vehicle action is based on the determined animal.

In Example 86, the subject matter of any of Examples 66-85 can optionally include that the vehicle is an aircraft.

In Example 87, the subject matter of any of Examples 66-85 can optionally include that the vehicle is a watercraft.

In Example 88, the subject matter of any of Examples 66-85 can optionally include that the vehicle is an automobile.

In Example 89, the subject matter of any of Examples 66-88 can optionally include that the vehicle action is further based on weather conditions.

Example 90 is a non-transitory computer readable medium storing instructions thereon that, when executed via one or more processors of a vehicle, control the vehicle to perform any of the methods of Examples 66-89.

While the disclosure has been particularly shown and described with reference to specific aspects, it should be understood by those skilled in the art that various changes in form and detail may be made therein without departing from the spirit and scope of the disclosure as defined by the appended claims. The scope of the disclosure is thus indicated by the appended claims and all changes, which come within the meaning and range of equivalency of the claims, are therefore intended to be embraced.

What is claimed is:

1. A vehicle controlling apparatus, comprising:
one or more receivers configured to receive an animal tracking signal from an animal tracking device affixed to an animal and storing animal attribute data associated with the animal;
wherein the animal tracking signal includes the animal attribute data;
one or more processors configured to
process the received the animal attribute data to determine the animal will be in a path of the vehicle;
determine a vehicle action based on the determination that the animal will be in the path of the vehicle, and
control a vehicle according to the vehicle action.

2. The apparatus of claim 1, wherein the one or more receivers receive the animal tracking signal via an intermediary transceiver.

3. The apparatus of claim 1, further comprising one or more transmitters, wherein the one or more transmitters are configured to transmit an input signal comprising the animal attribute data to a server.

4. The apparatus of claim 3, wherein the server is configured to
predict an animal movement based on the animal attribute data;
transmit the animal movement to the vehicle; and
wherein the one or more receivers are further configured to receive the animal movement; and the vehicle action is further determined based on the animal movement.

5. The apparatus of claim 4 wherein the one or more processors are further configured to determine an animal movement based on the animal attribute data.

6. The apparatus of claim 5, wherein the vehicle action is to modify a light brightness.

7. The apparatus of claim 5, wherein the vehicle action is to produce a sound.

8. The apparatus of claim 5, wherein the vehicle action is to alter a vehicle direction.

9. The apparatus of claim 5, wherein the vehicle action is further based on weather conditions.

10. A method for animal collision avoidance, comprising:
receiving an animal tracking signal from an animal tracking device storing animal attribute data and affixed to an animal,
wherein the animal tracking signal includes the animal attribute data;
processing the received animal attribute data to determine the animal will be in a path of the vehicle action;
determining a vehicle action based on the determination that the animal will be in the path of the vehicle; and
controlling a vehicle according to the vehicle action.

11. The method of claim 10, further comprising transmitting an input signal comprising the animal attribute data to a server.

12. The method of claim 11, further comprising receiving an animal movement based on the animal attribute data; and where in the vehicle action is further determined based on the animal movement.

13. The method of claim 12, further comprising determining an animal movement based on the animal attribute data.

14. The method of claim 13, wherein the vehicle action is based on the determined animal movement.

15. The method of claim 10, further comprising enabling an indicator.

16. The method of claim 15, further comprising indicating a high risk route.

17. The method of claim 10 further comprising capturing an image.

18. The method of claim 17, further comprising determining an animal based on the captured image.

19. The method of claim 18, wherein the captured image is an obstructed view of the animal.

20. The method of claim 19, wherein the vehicle action is based on the determined animal.
